(19) United States
(12) Patent Application Publication
(10) Pub. No.: US 2013/0058027 A1
(43) Pub. Date: Mar. 7, 2013

(54) FOLDABLE ELECTRONIC DEVICE

(71) Applicants: Hung-Chi Chen, Taipei City (TW); Chia-Te Tsao, Taipei City (TW); Chung-Kuo Lai, Taipei City (TW)

(72) Inventors: Hung-Chi Chen, Taipei City (TW); Chia-Te Tsao, Taipei City (TW); Chung-Kuo Lai, Taipei City (TW)

(73) Assignee: COMPAL ELECTRONICS, INC., Taipei City (TW)

(21) Appl. No.: 13/598,614

(22) Filed: Aug. 30, 2012

Related U.S. Application Data
(60) Provisional application No. 61/530,392, filed on Sep. 1, 2011.

(51) Int. Cl. G06F 1/16

(52) U.S. Cl. 361/679.27

(57) ABSTRACT

A foldable electronic device includes a first body and a second body, in which the second body is pivoted to the first body. The second body includes a display cover, a display module, at least one battery module and a pivot mechanism. The display cover has a display region and a battery cavity, in which the display region is adjacent to the battery cavity and the display module is installed to the display region of the display cover. The battery module is disposed in the battery cavity. The pivot mechanism is disposed between the first body and the second body and adjacent to the side wall of the battery cavity to make the second body rotate relatively to the first body on a pivoting axis.

### CROSS-REFERENCE TO RELATED APPLICATION

This application claims the priority benefits of U.S. provisional application Ser. No. 61/530,392, filed on Sep. 1, 2011. The entirety of the above-mentioned patent application is hereby incorporated by reference herein and made a part of this specification.

### BACKGROUND OF THE INVENTION

1. Field of the Invention

The invention generally relates to an electronic device, and more particularly, to a foldable electronic device.

2. Description of Related Art

The foldable electronic device (for example, notebook computer) has advantage of slim body and carry convenience, so that if a user has to go out and still needs to use the computer, it is most likely to buy a notebook computer with him. In order to reduce the burden for a user with the notebook computer to go out, in the design of the notebook, the thickness of the body must be reduced to the smallest.

FIG. 1 is a partial cross-sectional view of a conventional notebook computer. Referring to FIG. 1, the conventional notebook computer 100 includes a display cover 110, a display frame 120, a battery module 130, which are sequentially stacked from up to down in the thickness direction thereof. The battery module 130 includes a battery external shell 131 and a battery cell 132. The battery module 130 is plugged into a battery cavity 141 of the body 140 of the foldable electronic device 100.

Under a certain thickness restriction of the battery module 130 itself, to reduce the thickness of the body meanwhile keeping the relative positions of the parts of the foldable electronic device 100 unchanged, only way is to remove a part of the display cover 110 and a part of the display frame 120 that cover the battery module 130. However, the above-mentioned design would affect the appearance of the foldable electronic device 100, in particular the appearance of the display cover 110. Thus, how to reduce the thickness of the foldable electronic device 100 to the thinnest without affecting the appearance thereof becomes an important project and a challenge.

### SUMMARY OF THE INVENTION

Accordingly, the invention is directed to a foldable electronic device able to reduce the thickness thereof after being folded.

The invention provides a foldable electronic device, which includes a first body and a second body, in which the second body is pivoted to the first body. The second body includes a display cover, a display module, at least one battery module and a pivot mechanism. The display cover has a display region and a battery cavity, in which the display region is adjacent to the battery cavity and the display module is installed to the display region of the display cover. The battery module is disposed in the battery cavity. The pivot mechanism is disposed between the first body and the second body and adjacent to the side wall of the battery cavity to make the second body rotate relatively to the first body on a pivoting axis.

Based on the description above, the display cover of the foldable electronic device in the invention has a battery cavity, the battery module is installed in the battery cavity. Then, by using a battery cover installed to the display cover and the battery cavity together, the battery module is fixed. In this way, the battery module is accommodated without a battery external shell so as to reduce the thickness of the foldable electronic device after folding.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a partial cross-sectional view of a conventional notebook computer.

FIG. 2 is a perspective view of a foldable electronic device in unfolding state according to an embodiment of the invention.

FIG. 3 is an exploded view of the second body of the foldable electronic device in FIG. 2.

FIG. 4 is a partial cross-sectional view of the second body of the foldable electronic device 200 in FIG. 2.

FIG. 5 is a perspective view of a foldable electronic device in unfolding state according to another embodiment of the invention.

FIG. 6 is a partial side view of the foldable electronic device in FIG. 5 in folding state.

FIG. 7 is a partial side view of the foldable electronic device in FIG. 6 in unfolding state.

FIG. 8 is a partial side view of a foldable electronic device in folding state according to yet another embodiment of the invention.

FIG. 9 is a partial side view of the foldable electronic device in FIG. 8 in unfolding state.

### DESCRIPTION OF THE EMBODIMENTS

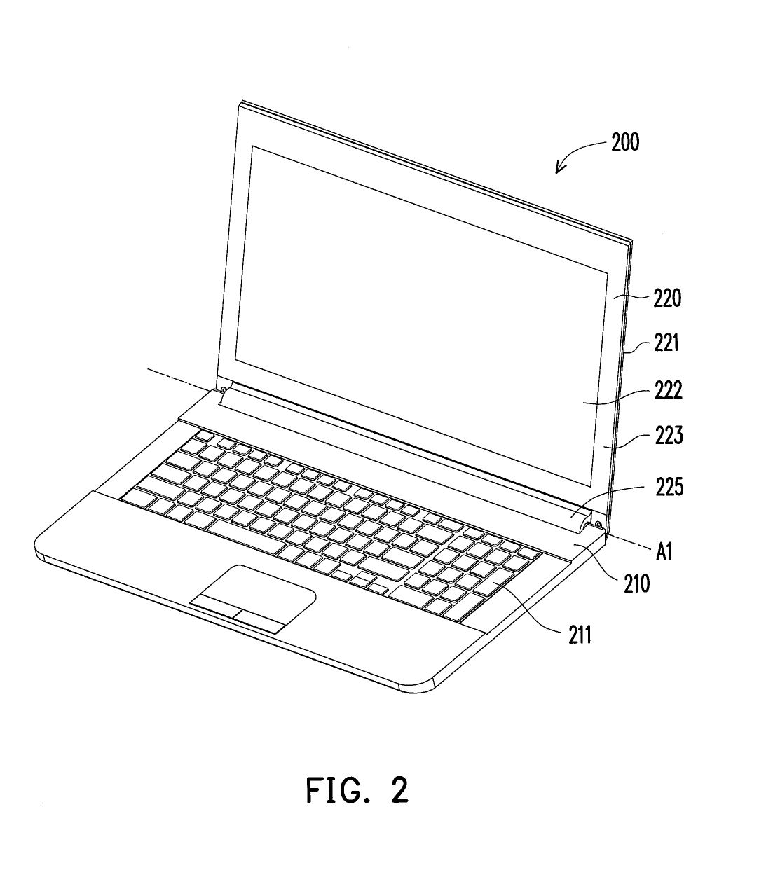

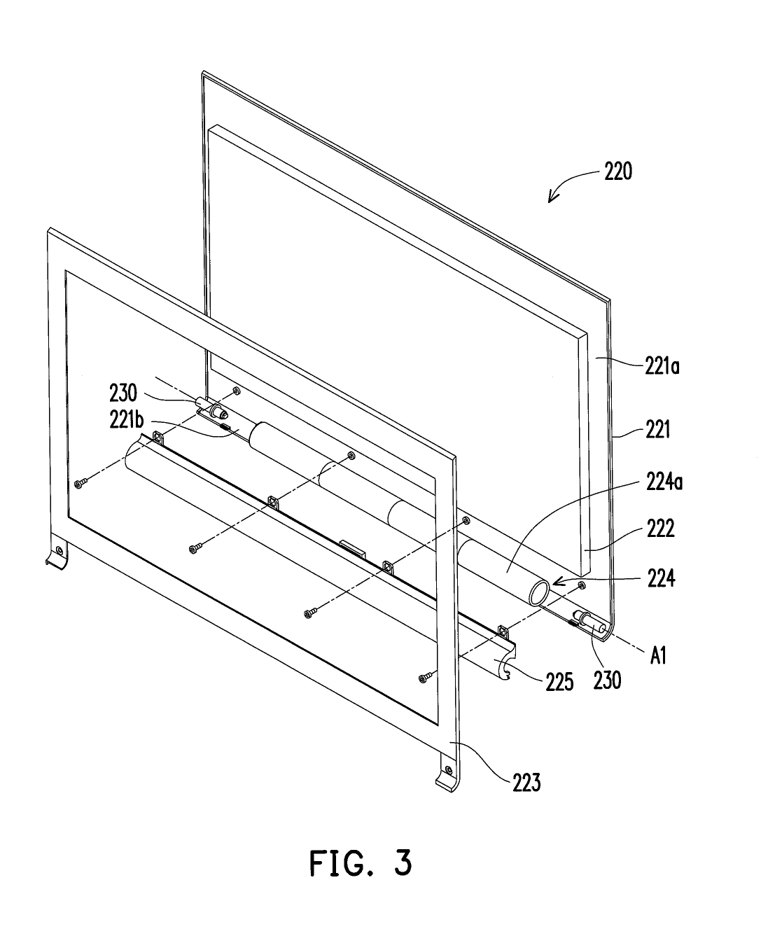

FIG. 2 is a perspective view of a foldable electronic device in unfolding state according to an embodiment of the invention and FIG. 3 is an exploded view of the second body of the foldable electronic device in FIG. 2. Referring to FIGS. 2 and 3, the foldable electronic device 200 includes a first body 210 and a second body 220. The foldable electronic device 200 of the embodiment is, for example, a notebook computer, which the invention is not limited to. As shown by FIG. 3, the second body 220 of the foldable electronic device 200 includes a display cover 221, a display module 222, a frame 223, at least one battery cell 224a (multiple ones in FIG. 3) and a battery cover 225. The invention does not limit the quantity of the battery cell 224a.

Depending on different product design, the multiple battery cells 224a may form one battery module 224 or respectively form a plurality of battery modules 224, which the invention is not limited to. The display cover 221 is pivoted to the first body 210 on a pivoting axis A1 and has a display region 221a and a battery cavity 221b, in which the display region 221a is adjacent to the battery cavity 221b. The display module 222 is installed to the display region 221a of the display cover 221, and the frame 223 is installed to the display region 221a of the display cover 221 and exposes a part of the display module 222. The battery module 224 is installed in the battery cavity 221b and adjacent to the display module 222. The battery cover 225 is installed to the display cover 221 and together with the battery cavity 221b fixes the battery cells 224a. Depending on different product design, the frame 223 and the display cover 221 may be integrally formed as a component to protect the side wall of the display module 222, which the invention is not limited to. The battery cover 225 and the frame 223 may be integrally formed as a component so as to fix the battery module 224 during mounting the frame 223.

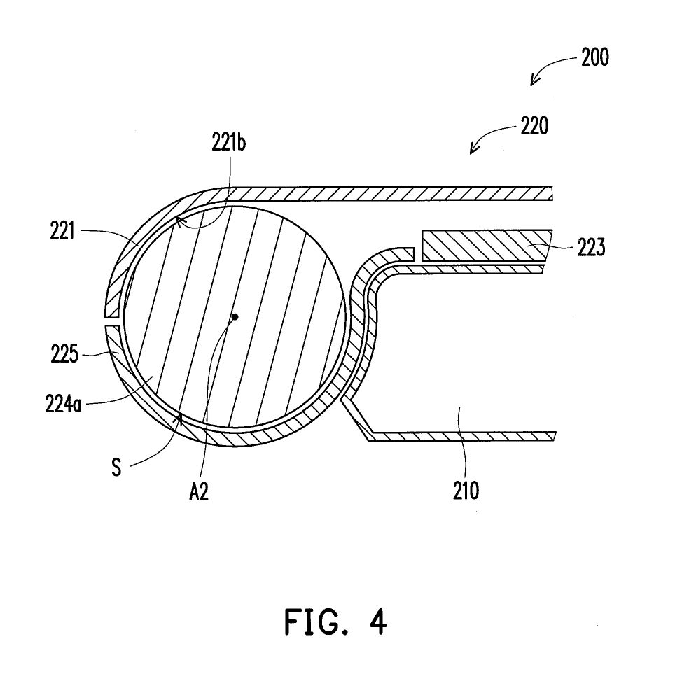

FIG. 4 is a partial cross-sectional view of the second body of the foldable electronic device 200 in FIG. 2. Referring to FIGS. 3 and 4, the battery cells 224a of the embodiment are arranged in a straight line. Each of the battery cells 224a is in cylinder shape and arranged in a straight line, in which the straight line is coincident with all the center axes A2 of all the battery cells 224a. The battery cavity 221b of the display cover 221 and the battery cover 225 together form a cylinder-shaped space S to accommodate the battery cells 224a in cylinder shape. Depending on different product design, the battery cells 224a may be a cuboid shape, which the invention is not limited to.

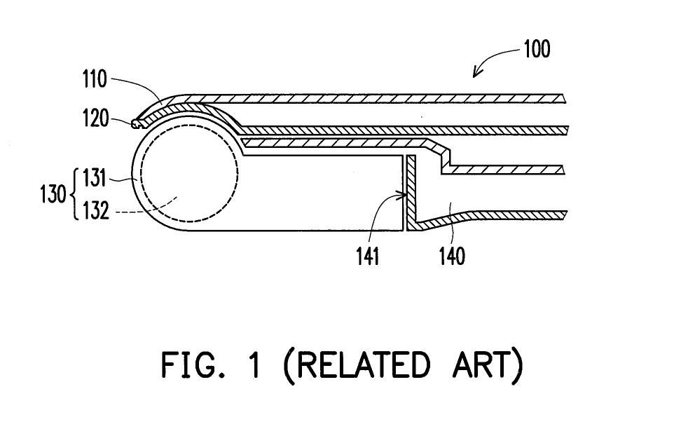

In the embodiment, the cylinder-shaped space S may be formed by the battery cavity 221b of the display cover 221 and the battery cover 225, and the battery cells 224a are placed in the cylinder-shaped space S. Thus, in the embodiment, the battery cells 224a are not necessarily accommodated in a conventional and extra-fabricated battery external shell, but the battery cells 224a are directly mounted at the display cover 221. As shown by FIG. 4, in the foldable electronic device 200 of the embodiment, the display cover 221, the battery cells 224a and the battery cover 225 are sequentially stacked from up to down in the thickness direction thereof. In comparison with the conventional foldable electronic device (for example, the conventional notebook computer 100 in FIG. 1), the foldable electronic device 200 of the embodiment may reduce the thickness after assembling so as to have advantage of slim body.

Referring to FIG. 3 again, in order to assemble the battery cover 225 to the display cover 221, a side of the battery cover 225 needs to be locked to the display cover 221, followed by fastening another side of the battery cover 225 to the display cover 221. The battery cover 225 can be fastened on the display cover 221 by using fasteners (for example, screws), which the invention is not limited to.

Referring to FIGS. 2 and 3, the foldable electronic device 200 further includes a pivot mechanism 230, which is disposed between the first body 210 and the display cover 221 of the second body 220, where the display cover 221 is pivoted to the first body 210 through the pivot mechanism 230 on the pivoting axis A1, and the pivot mechanism 230 is adjacent to the side wall of the battery cavity 221b on the display cover 221. As shown by FIG. 3, the foldable electronic device 200 of the embodiment may include two pivot mechanisms 230 respectively located at the left and right sides of the display cover 221, which the invention is not limited to. The user can rotate the second body 220 relatively to the first body 210 through the pivot mechanism 230, so that the foldable electronic device 200 has an unfolding state and a folding state. Depending on different product design, the pivot mechanism 230 may be also directly disposed at the side wall of the battery cavity 221b, which the invention is not limited to.

In addition, as shown by FIG. 2, the first body 210 of the foldable electronic device 200 may have a keyboard 211. When the foldable electronic device 200 is in folding state, the first body 210 and the second body 220 are superposed by each other and the display module 222 of the second body 220 faces the keyboard 211. When the foldable electronic device 200 is in unfolding state, the user can enter text by using the keyboard 211 and watch the frame given by the display module 222.

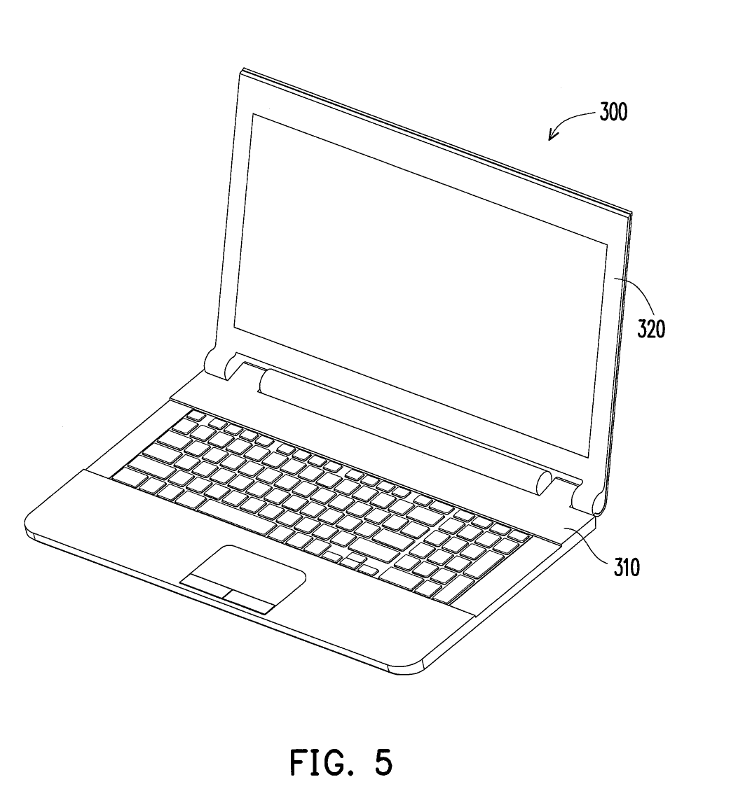

FIG. 5 is a perspective view of a foldable electronic device in unfolding state according to another embodiment of the invention. Referring to FIG. 5, the foldable electronic device 300 of the embodiment has the same components and layout as the first embodiment, which is omitted to describe. The difference of the embodiment from the one of FIG. 2 rests in that the two foldable electronic devices have different figures. The second body 320 has two extension portions with a shape similar to the battery cover and respectively disposed at both sides of the second body 320. Correspondingly, the first body 310 has two dents corresponding to the portions of the two extension portions.

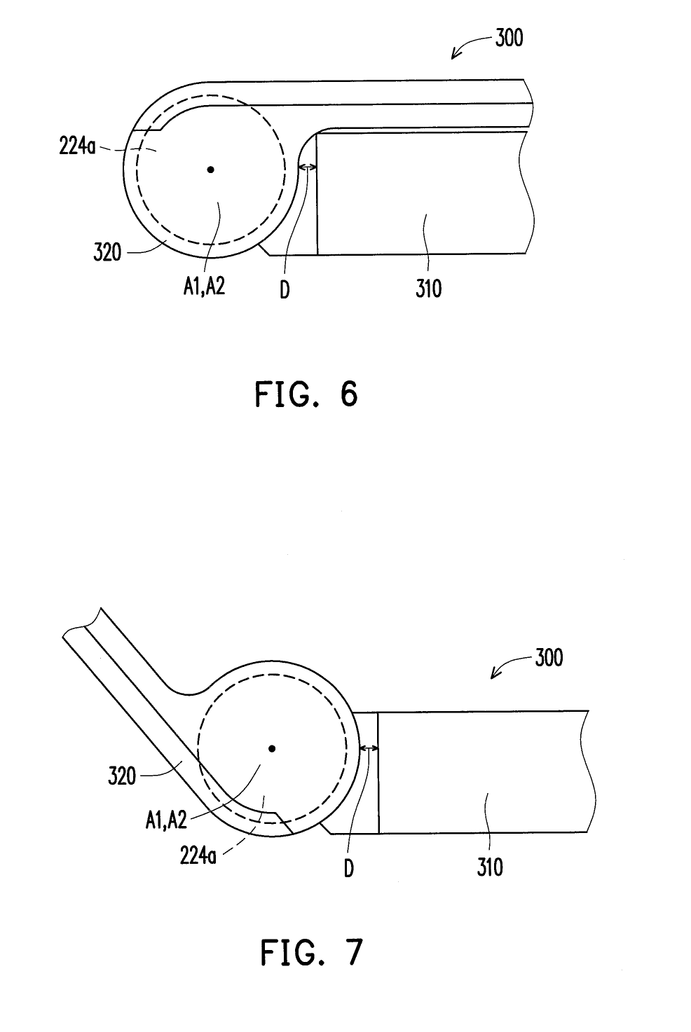

FIG. 6 is a partial side view of the foldable electronic device in FIG. 5 in folding state and FIG. 7 is a partial side view of the foldable electronic device in FIG. 6 in unfolding state. Referring to FIGS. 6 and 7, there is an interval D between the first body 310 and the second body 320 of the foldable electronic device 300. If the center axes A2 of the battery cells 224a are coincident with the pivoting axis A1, the interval D keels unchanged during the course of the foldable electronic device 300 from the folding state to the unfolding state.

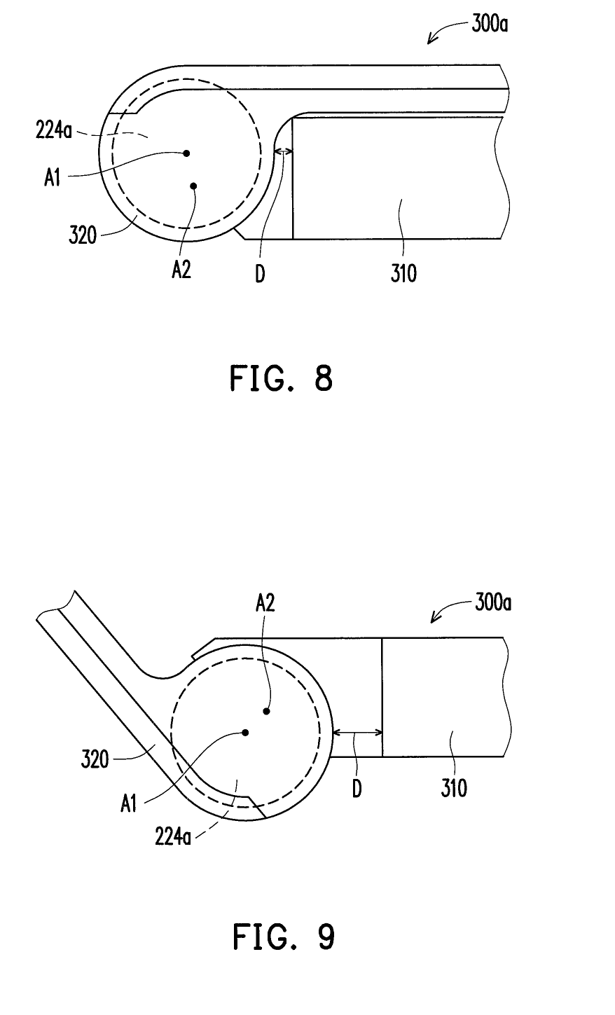

The center axes A2 of the battery cells 224a are not necessarily coincident with the pivoting axis A1. FIG. 8 is a partial side view of a foldable electronic device in folding state according to yet another embodiment of the invention and FIG. 9 is a partial side view of the foldable electronic device in FIG. 8 in unfolding state. Referring to FIGS. 8 and 9, for the foldable electronic device 300a, the center axes A2 of the battery cells 224a are not coincident with the pivoting axis A1, instead, parallel to the pivoting axis A1 and away from the pivoting axis A1 by a distance. Under the above-mentioned layout, during unfolding the foldable electronic device 300a through a rotation, the interval D between the first body 310 and the second body 320 would be gradually wider.

In summary, the battery cells of the foldable electronic device in the invention are installed in the battery cavity of the display cover, and the battery cover and the battery cavity together fix the battery cells. In this way, no extra battery external shell is needed, which may reduce the thickness after folding so as to have advantage of slim body. In addition, the center axes of the battery cells may be coincident with the pivoting axis or parallel to the pivoting axis so as to bring the foldable electronic device with good design flexibility.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A foldable electronic device, comprising:
a first body; and
a second body pivoted to the first body, the second body comprising:
a display cover has a display region and a battery cavity, wherein the display region is adjacent to the battery cavity;
a display module installed to the display region of the display cover;
at least a battery module disposed in the battery cavity; and
a pivot mechanism disposed between the first body and the second body and adjacent to the side wall of the battery cavity to make the second body rotate relatively to the first body on a pivoting axis.

2. The foldable electronic device as claimed in claim 1, further comprising:
a frame installed to the display region of the display cover and exposing a portion of the display module.

3. The foldable electronic device as claimed in claim 2, further comprising:
a battery cover being integrally formed as a component with the frame.

4. The foldable electronic device as claimed in claim 1, further comprising:
a battery cover installed to the display cover and fixing the battery cells 224a together with the battery cavity.

5. The foldable electronic device as claimed in claim 4, wherein the battery module is in cylinder shape, and the battery cavity of the display cover and the battery cover form a cylinder-shaped space to accommodate the battery module.

6. The foldable electronic device as claimed in claim 4, wherein a side of the battery cover is locked to the display cover, and another side of the battery cover is fastened to the display cover.

7. The foldable electronic device as claimed in claim 1, wherein the battery module comprising:
a plurality of battery cells are arranged in a straight line.

8. The foldable electronic device as claimed in claim 1, wherein the battery module comprising:
a plurality of battery cells, wherein each of the battery cells is in cylinder shape and arranged in a straight line, and the straight line is coincident with all the center axes of all the battery cells.

9. The foldable electronic device as claimed in claim 1, wherein the battery module comprising:
a plurality of battery cells are arranged in a straight line, wherein each of the battery cells is in cylinder shape, and the center axes of the battery cells are coincident with the pivoting axis between the first body and the second body.

10. The foldable electronic device as claimed in claim 1, wherein the battery module comprising:
a plurality of battery cells are arranged in a straight line, wherein each of the battery cells is in cylinder shape, and the center axes of the battery cells are parallel to the pivoting axis between the first body and the second body.

11. The foldable electronic device as claimed in claim 1, wherein the first body has a keyboard 211, and when the first body and the second body are superposed by each other, the display module faces the keyboard.

12. The foldable electronic device as claimed in claim 1, wherein the pivot mechanism is disposed at the side wall of the battery cavity.
